(19) United States
(12) Patent Application Publication
(10) Pub. No.: US 2012/0066760 A1
(43) Pub. Date: Mar. 15, 2012

(54) ACCESS CONTROL IN A VIRTUAL SYSTEM

(75) Inventors: Ray W. Anderson, Liberty Hill, TX (US); Saurabh Desai, Austin, TX (US); George M. Koikara, Bangalore (IN); Ponnuvel Palaniyappan, Tiruchirappali (IN)

(73) Assignee: International Business Machines Corporation, Armonk, NY (US)

(21) Appl. No.: 12/879,686

(22) Filed: Sep. 10, 2010

(51) Int. Cl. G06F 21/00

(52) U.S. Cl. 726/17

(57) ABSTRACT

A method comprises determining a set of one or more authorizations associated with a role of a user responsive to the user entering a command with a parameter, wherein the command with the parameter is to be implemented via a first virtual partition that is configured to control access to a plurality of virtual input/output (I/O) devices by a plurality of other virtual partitions. The first virtual partition and the plurality of other virtual partitions are instantiated on a same system. The method includes determining that the role is authorized to execute the command based on the set of one or more authorizations. The method also includes determining that the role is authorized to execute the command with the parameter responsive to determining that the role is authorized to perform the command. The method includes executing the command with the parameter via the virtual partition.

### BACKGROUND

Virtualization technology allows for sharing of different resources (e.g., memory, network access, processors, storage, etc.) across multiple partitions or virtual machines (known as clients). In one such environment, a virtual input/output server (VIOS) owns the physical resources and acts as a server to the virtual machines that are connected to the server.

### SUMMARY

Embodiments include a method that comprises determining a set of one or more authorizations associated with a role of a user responsive to the user entering a command with a parameter, wherein the command with the parameter is to be implemented via a first virtual partition that is configured to control access to a plurality of virtual input/output (I/O) devices by a plurality of other virtual partitions. The first virtual partition and the plurality of other virtual partitions are instantiated on a same system. The method includes determining that the role is authorized to execute the command based on the set of one or more authorizations. The method also includes determining that the role is authorized to execute the command with the parameter responsive to determining that the role is authorized to perform the command. The method includes executing the command with the parameter via the virtual partition.

Embodiments include a computer program product for access control in a virtual environment. The computer program product comprises a computer readable storage medium having computer readable program code embodied therewith. The computer readable program code is configured to determine a set of one or more authorizations associated with a role of a user responsive to the user entering a command with a parameter. The command with the parameter is to be implemented via a first virtual partition that is configured to control access to a plurality of virtual input/output (I/O) devices by a plurality of other virtual partitions. The first virtual partition and the plurality of other virtual partitions are instantiated on a same system. The computer readable program code is configured to determine that the role is authorized to execute the command based on the set of one or more authorizations. The computer readable program code is configured to determine that the role is authorized to execute the command with the parameter responsive to determining that the role is authorized to perform the command. The computer readable program code is configured to execute the command with the parameter via the virtual partition.

Embodiments include an apparatus having a processor. The apparatus includes a machine-readable storage medium encoded with virtual partition instructions executable by the processor. The virtual partition instructions are configured to execute through a first virtual partition that is configured to control access to a plurality of virtual input/output (I/O) devices by a plurality of other virtual partitions. The first virtual partition and the plurality of other virtual partitions are instantiated on a same system. The virtual partition instructions are configured to determine a set of one or more authorizations associated with a role of a user responsive to the user entering a command with a parameter, wherein the command with the parameter is to be implemented via the first virtual partition. The virtual partition instructions are configured to determine that the role is authorized to execute the command based on the set of one or more authorizations. The virtual partition instructions are configured to determine that the role is authorized to execute the command with the parameter responsive to determining that the role is authorized to perform the command. The virtual partition instructions are configured to execute the command with the parameter via the virtual partition.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a computer device having virtual machines for sharing resources, according to some example embodiments.

FIG. 2 is a block diagram illustrating dynamic access control in a virtual environment, according to some example embodiments.

FIG. 3 is a flowchart of operations for dynamic access control for user roles in a virtual environment, according to some example embodiments.

FIG. 4 illustrates dynamic updates to the defined roles for user access control in a virtual environment, according to some example embodiments.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. In other instances, well-known instruction instances, protocols, structures, and techniques have not been shown in detail in order not to obfuscate the description.

Some example embodiments include a virtual environment. Operating system virtualization is a technology which can divide a single host (e.g., computer, server, etc.), into multiple parts, or partitions, each running a separate instance, or image, of an operating system (OS). The instances of the operating systems are separate, or isolated, from each other in some ways. For example, the instances of the operating systems have separate file systems, separate users, separate applications, and separate processes. In other ways, however, the instances of the operating systems are not separate and can share some resources of the host. For example, the instances of the operating systems can share the memory, the kernel, the processors, the network cards, the hard drives, and/or other software, firmware, and/or hardware of the host. Thus, each instance of the operating system can look and feel like a separate server or machine from the point of view of its users. However, because the instances of the operating system share resources of the host, the instances of the operating systems are not actually separate devices. The instances of the operating system are commonly referred to as “virtual” or “virtualized” operating systems (virtual OS's). In similar contexts, virtualized operating systems are also referred to as virtual partitions, virtual machines, virtual environments, or virtual servers.

Virtual OS's can be implemented in different ways. One way is for an administrative user to create a logical partition (LPAR) on a host and install an instance of an operating system on the LPAR. The administrative user can create a logical partition (LPAR) by dividing a portion, or subset, of the host's hardware resources, such as processors, memory, and storage. The administrative user can isolate the LPAR from other LPARs running on the same device or machine. Specifically, the administrative user isolates the subset of the host's hardware resources from other subsets, so that multiple LPARs can run on the host, with each LPAR being operating independently of each other, as if each LPAR was a separate machine. The administrative user can install an instance of the operating system on an LPAR. The instance of the operating system can run its own applications in a way that is separate and isolated from any other LPAR. The number of LPARs that can be created on a host, however, depends on the number of the host's resources available. For example, to create an LPAR, an administrative user must physically partition a portion of the host's memory and assign the portion of the host's memory to the LPAR. Because LPARs have separation at the hardware level, LPARs are very stable, can run different versions of an operating system, and provide a very high degree of isolation from other LPARs.

A different way to create a virtual OS is to form a workload partition (WPAR). WPARs were introduced in the IBM® AIX® 6.1 operating system. WPARs are a software implementation of operating system virtualization. More specifically, WPARs are software partitions that are created from, run under, and share the resources of a managing instance of the operations system (OS). The WPARs and the managing instance share an identical operating system (e.g., identical version, identical patches, identical tuning options, etc.). The managing instance of the OS is referred to as a global environment or the global OS. Multiple WPARs can run on a single managing resource (e.g., on a single machine or on a single LPAR). An administrative user does not need to physically divide up portions of the host's hardware to create a WPAR. Rather, the administrative user runs a command to generate a WPAR and the global OS creates and manages the WPAR as a software partition.

WPARs can be two types, a System WPAR and an Application WPAR. System WPARS are virtual system environments that have their own private file systems, users and groups, login, network space, and administrative domain. System WPARs managed by the global OS share the same kernel, the same memory, and some other resources that the global OS uses. Application WPARs are light weight environments used for isolating and executing one or many application processes. Because WPARs are software implementations, WPARs can easily be migrated from one managing resource to another (e.g., from one LPAR to another or from one machine to another).

Some example embodiments include a virtual operating system that controls and manages the physical resources relative to the different virtual partitions on the machine. In some example embodiments, this controlling virtual operating system is within a separate virtual partition. In some example embodiments, this controlling virtual operating system is a Virtual Input/Output Server (VIOS). For example, this controlling virtual operating system can allocate a physical resource A (e.g., a first hard disk drive) to a first LPAR, a physical resource B (e.g., a second hard disk drive) to a second LPAR, a physical resource C (e.g., a network card) to a third LPAR, etc. For ease of understanding, this control virtual operating system is referred to herein as a VIOS. However, this controlling virtual operating system is representative of any type of control module that controls and manages the physical resources relative to the different virtual partitions on the machine.

Some example embodiments incorporate a Role Based Access Control (RBAC) into the VIOS. RBAC is a security mechanism that provides access to users only if the users have necessary authorizations. A conventional virtual environment comprises predefined roles for users. For example, there are four different types of predefined roles (“View Only”, “Admin”, “SRUser”, and “DEUser”). Each of the predefined roles has access to a defined set of commands. This is enforced by checking the user type in the code and determining whether a particular command can be executed by that user type. Accordingly, assume a user type has access to commands A, B, and C. The system cannot add access to another command D or remove one of these existing commands, because of this static checking Therefore, in some conventional virtual environments, there are various commands that can be executed by users based on these predefined roles. One predefined role can executed a particular command, while a second predefined role cannot. Also, in some conventional virtual environments, the authorization for commands in these predefined roles is hardcoded. In particular, a static set of authorizations control user access to the commands. Currently, some virtual environments provide a set of users with a limited set of command access for each predefined role. These set of commands are static. An existing command cannot be removed from a particular predefined role. Also, a new command cannot be added to particular predefined roles.

Some example embodiments incorporate RBAC for VIOS commands with a single binary and without disrupting the existing model of VIOS. In particular, some example embodiments include one binary for the different commands. In some example embodiments, flexibility has been incorporated into a virtual environment to allow the creation of specific user roles that can be associated with specific commands. Therefore in accordance with some example embodiments, the access to any command can be extended to existing users. Also, existing commands can be removed from an access list of commands of a particular user. Accordingly, some example embodiments eliminate the static checking of user types. Also, some example embodiments allow the system to create users of any number of different access permissions. This is in contrast to conventional virtual environments that are limited to predefined user types.

In some example embodiments, a virtual environment comprises various commands to perform different functionalities. Access to these various commands can be based on parameters associated with the commands. Authorization can be defined relative to a command and associated parameter combination. A command can include one to N number of parameters. The authorization can be unique for a given unique command/parameter combination. For example, the authorization for command A with parameter X can be different than the authorization for the command A with the parameter Y. A user role can be defined relative to these authorizations and can have one to N number of authorizations. To illustrate, role A can have authorizations for the following: 1) command A with the parameter X; and 2) command D with the parameter N. Role B can have authorization for the following: 1) command A with the parameter Y; and 2) command F with the parameter Y. As noted above, the roles and the associated authorizations for command/parameter combinations can be dynamically created and updated. Accordingly, some example embodiments allow for a wide spectrum of roles with varying levels of granularity.

Some example embodiments allow for the implementing and enforcing of organization's securities policies that are consistent with regard to system management and access control. Also, a role or job function definition within an organization generally remains the same as compared to resources and users. Accordingly, role definition can be defined to the unique requirements for a given organization. Also, some example embodiments allow system function to be defined into smaller units, thus enabling greater system protection. Isolation can be enforced around smaller units of administration and can confine command functionality to the smallest unit.

Because of the dynamic configurability of the roles, some example embodiments reduce the possibility of making mistakes of commission and omission in granting privileges to users. Also, some example embodiments allow for enforcing of the traditional least privilege model of security. A very granular access to commands can be provided in a virtual environment. For example, it is possible to create a user with the ability to only access one option of a particular command and with no other access permissions.

Some example embodiments provide the ability to split management functions across multiple types of users. This is in contrast to conventional virtual environments that concentrate these functions into a single user type. Some example embodiments provide better security by giving only the necessary access to users. This also allows for easy management and auditing of system functions. Also, the enabled privileges are given to the executing process for only a short period of time. In particular, the privileges can be withheld whenever the user is not performing an operation. Accordingly, security is improved by giving privileges only when needed.

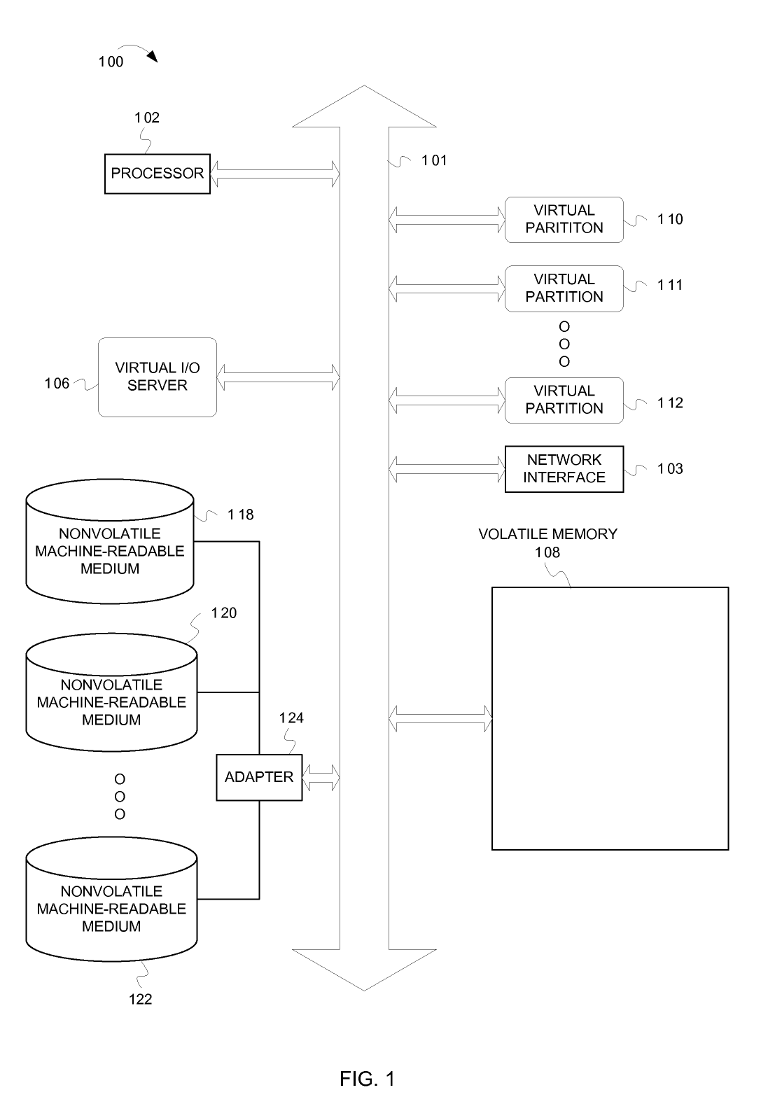

FIG. 1 is a block diagram illustrating a computer device with a virtualized environment, according to some example embodiments. A computer device 100 includes a processor 102 (possibly including multiple processors, multiple cores, multiple nodes, and/or implementing multi-threading, etc.). The computer device 100 includes a nonvolatile machine-readable medium 118, a nonvolatile machine-readable medium 120 and a nonvolatile machine-readable medium 122 that are communicatively coupled to the bus 101 through an adapter 124. The nonvolatile machine-readable media 118-122 can be various types of hard disk drives (e.g., optical storage, magnetic storage, etc.). The computer device 100 also includes a bus 101 (e.g., PCI, ISA, PCI-Express, HyperTransport®, InfiniBand®, NuBus, etc.) and a network interface 103 (e.g., an ATM interface, an Ethernet interface, a Frame Relay interface, SONET interface, wireless interface, etc.).

The computer device 100 includes a virtual I/O server 106 and a number of virtual machines (a virtual machine 110, a virtual machine 111 and a virtual machine 112). In some example embodiments, each of the virtual machines 110-112 serves as a software implementation of a machine. Each of the virtual machines 110-112 can provide a system platform that enables execution of an operating system. As further described below, the virtual machines 110-112 share physical resources of the computer device 100.

The operations of the virtual I/O server 106 and the virtual machines 110-112 are described in more detail below. Any one of these operations can be partially (or entirely) implemented in hardware and/or on the processor 102. For example, the operations can be implemented with an application specific integrated circuit, in logic implemented in the processor 102, in a co-processor on a peripheral device or card, etc. The computer device 100 includes a volatile memory 108. The volatile memory 108 can be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the below described possible realizations of machine-readable media.

Further, realizations may include fewer or additional components not illustrated in FIG. 1 (e.g., video cards, audio cards, additional network interfaces, peripheral devices, etc.). The processor 102, the volatile memory 108, the nonvolatile machine-readable media 118-122, the virtual I/O server 106, the virtual machines 110-112, and the network interface 103 are coupled to the bus 101. Although illustrated as being coupled to a bus 101, the volatile memory 108 can be coupled to the processor 102.

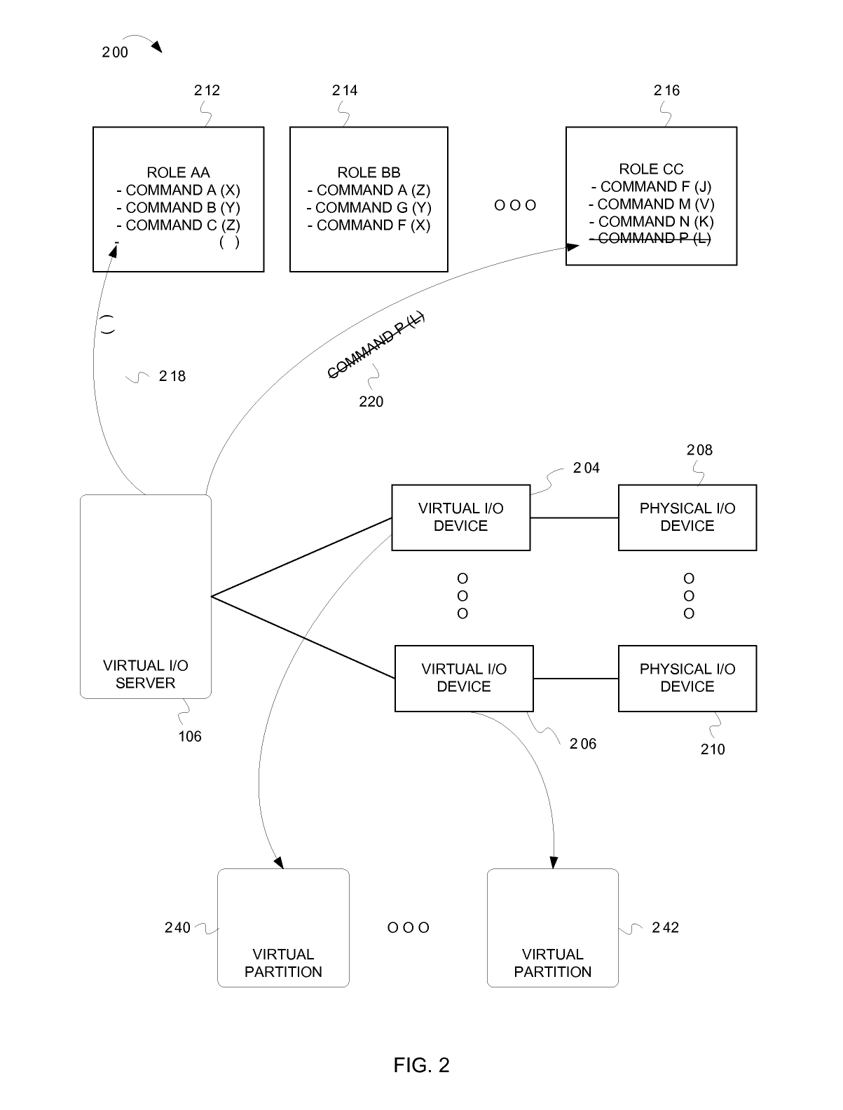

The dynamic access control in a virtual environment is now described. In particular, FIG. 2 is a block diagram illustrating dynamic access control in a virtual environment, according to some example embodiments. FIG. 2 includes a system 200. The system 200 includes the VIOS 106, a virtual I/O device 204, a virtual I/O device 206, a physical I/O device 208, and a physical I/O device 210. As shown, the virtual I/O devices 204-206 represent the physical I/O devices 208-210, respectively. In the system 200, there can be one to N number of these I/O devices. Examples of the I/O devices include storage devices, network cards, printers, audio output devices, video output devices, etc. The volatile memory 108, nonvolatile machine-readable media 118-122, and the network interface 103 in FIG. 1 are examples of such I/O devices.

The VIOS 106 is a virtual partition in the system 200 and controls access to the physical I/O devices 208-210. The VIOS 106 can create a virtual representation for each of the physical I/O devices 208-210. In this example, the VIOS 106 creates the virtual I/O device 204 as the virtual representation of the physical I/O device 208. The VIOS 106 creates the virtual I/O device 206 as the virtual representation of the physical I/O device 210. The virtual I/O devices 204-206 can be software interfaces that enable access to the associated physical I/O devices. The VIOS 106 is communicatively coupled to the virtual I/O devices 204-206 for creating and defining access thereto.

The system 200 also includes a virtual partition 240 and a virtual partition 242. The system 200 can include one to N number of these virtual partitions. Each of the virtual I/O devices 204-206 can be assigned to one or more of the virtual partitions 240-242. In this example, the virtual I/O device 204 is assigned to the virtual partition 240. The virtual I/O device 206 is assigned to the virtual partition 242. For example, the virtual I/O device 204 can be representative of a network interface card that is assigned to the virtual partition 240. Accordingly, applications and processes executing in the virtual partition (e.g., WPAR) can use this network interface card for accessing a network coupled to the system 200. In another example, the virtual I/O device 206 can be representative of a nonvolatile machine-readable medium. Accordingly, applications and processes executing in the virtual partition 242 can store data into this nonvolatile machine-readable medium.

Also, in FIG. 2, different roles can be dynamically created, updated, etc. to be assigned to users accessing the system 200. In some example embodiments, the creating, updating, etc. of the different roles are executed through the VIOS 106. This is in contrast to conventional virtual environments that had predefined roles for users that could not be dynamically created, modified, etc. In some example embodiments, an authorization is assigned to a combination of a command and parameter. Examples of commands include create virtual I/O devices to represent a physical I/O device, associate a virtual I/O device to a virtual partition, etc. In some example embodiments, one command/binary is used with different parameters to perform different operations. For example, the command “mkvdev” is used to make N number of virtual devices. The type of virtual device is dependent on the parameter. For example, “mkvdev-sea” has the command “mkvdev” and the parameter of “-sea”. The parameter represents a shared network adapter. Accordingly, when this combination of the command and parameter is executed, a virtual I/O device is created for a shared network adapter. A different parameter can create a different virtual I/O device. For example, for the command/parameter combination of “mkvdev-optical”, the parameter represents an optical hard drive. Accordingly, when this combination of the command and parameter is executed, a virtual I/O device is created for an optical hard drive.

Therefore, a combination of command A/parameter X has an authorization M, and a combination of command A/parameter Y has an authorization N. In some example embodiments, different roles have different authorizations. A role can have one to N number of authorizations. With reference to the example in FIG. 2, the system 200 includes a role AA 212, a role BB 214 and a role CC 216. The VIOS 106 can create one to N number of roles. In this example, the VIOS 106 created the role AA 212, the role BB 214 and the role CC 216. The role AA 212 includes authorizations for three different command and parameter combinations: 1) command A with a parameter X; 2) command B with a parameter of Y; and 3) command C with a parameter of Z. Also shown as 218, the VIOS 106 is updating the role AA 212 to add an authorization to execute the command and parameter combination: command C with a parameter of N. The role BB 214 includes authorizations for three different command and parameter combinations: 1) command A with a parameter of Z; 2) command G with a parameter of Y; and 3) command F with a parameter of X. The role CC 216 includes authorizations for three different command and parameter combinations: 1) command F with a parameter of J; 2) command M with a parameter of V; and 3) command N with a parameter of K. Also shown as 220, the VIOS 106 is updating the role CC 216 to delete the authorization to execute the command and parameter combination: command P with a parameter of N.

In some example embodiments, the VIOS 106 can create and update the roles at any point of the operation of the system 200. For example, the VIOS 106 can create and update during initiation of the system 200, after creation of any or all of the virtual partitions or any of the virtual I/O devices, etc.

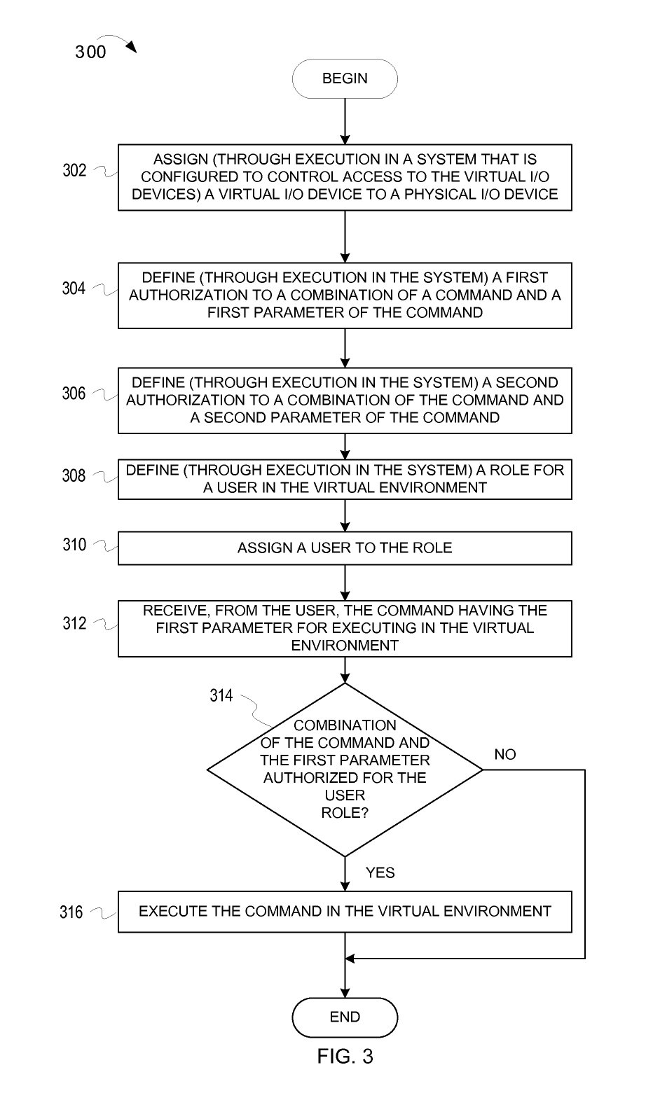

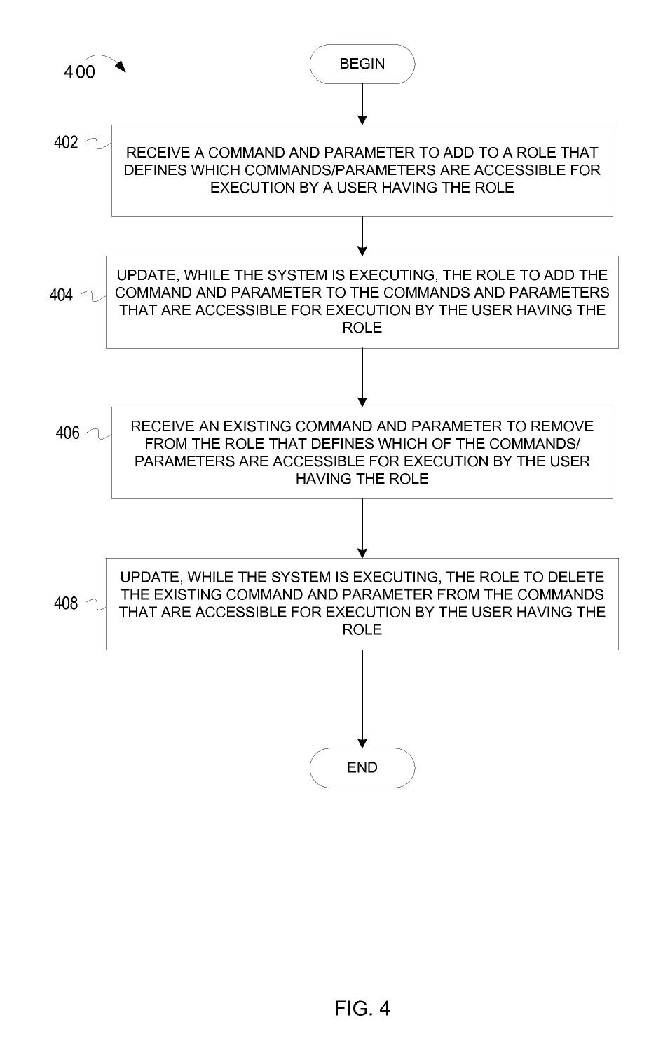

Operations for dynamic access control in a virtual environment are now described. In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flowchart. Two different flowcharts are now described. FIG. 3 illustrates defining the user access control and executing a command based on the user access control in a virtual environment. FIG. 4 illustrates dynamic updates to the defined roles for user access control in a virtual environment. The operations in both FIG. 3 and FIG. 4 can be from the perspective of the system controlling access to virtual I/O devices. In this example, the operations are performed from the perspective of the VIOS 106.

In particular, FIG. 3 is a flowchart of operations for dynamic access control for user roles in a virtual environment, according to some example embodiments. A flowchart 300 is described with reference to FIGS. 1-2.

The VIOS 106 assigns a virtual I/O device to a physical I/O device (302). The VIOS 106 can create a virtual I/O device for each physical I/O device in the virtual environment. In some example embodiments, the VIOS 106 creates a virtual I/O device for each physical I/O device that is to be shared among the virtual partitions. The virtual I/O device can be a software interface that enables access to a physical I/O device. Also, access can be assigned to one or more virtual partitions (as further described below). With reference to FIG. 2, the VIOS 106 can create the virtual I/O device 204 and the virtual I/O device 206. The VIOS 106 can assign the virtual I/O device 204 as a representation of the physical I/O device 208. The VIOS 106 can assign the virtual I/O device 206 as a representation of the physical I/O device 210. As described above, the I/O devices can be storage devices, network interface cards, volatile memory, audio output devices, video output devices, etc. Operations of the flowchart 300 continue.

The VIOS 106 defines a first authorization to a combination of a command and a first parameter of the command (304). The first authorization can be any type of alphanumeric value that is unique relative to other defined authorizations in the virtual environment. In some example embodiments, the VIOS 106 creates a data structure (e.g., a table) for storage of these authorizations. For example, each authorization can be in a table entry in a table. Also, the data structure can reside within the memory of the kernel of the VIOS 106. As described above, an authorization of a command with a first parameter can be different from an authorization of the same command with a second parameter. Such distinction provides the ability to define system functions into smaller units, thus enabling greater system protection. This isolation can be enforced around smaller units of administration and can confine command functionality to the smallest unit. As described above, examples of commands include create virtual I/O devices to represent a physical I/O device, associate a virtual I/O device to a virtual partition, etc. In some example embodiments, one command/binary is used with different parameters to perform different operations. See the examples in the description above regarding the command “mkvdev” is used to make virtual devices. Operations of the flowchart 300 continue.

The VIOS 106 defines a second authorization to a combination of the command and a second parameter of the command (306). Similar to the first authorization, the second authorization can be any type of alphanumeric value that is unique relative to other defined authorizations in the virtual environment. Also, the second authorization can reside in a same data structure as the first authorization, but within a different entry (e.g., different table entry). Also, the flowchart 300 only describes defining two authorizations. However, the VIOS 106 can define one to N number of authorizations. Operations of the flowchart 300 continue.

The VIOS 106 defines a role for a user in the virtual environment (308). The VIOS 106 can define one to N number of roles that are assignable to users. Such a configuration provides a very granular access to the commands. With reference to FIG. 2, the VIOS 106 created the role AA 212, the role BB 214, and the role CC 216. Each defined role can include a unique combination of authorizations for execution of command/parameter combinations. For example, a first role can be limited to network-based commands; a second role can be limited to nonvolatile storage devices; a third role can create roles in the system; a fourth role can associate users to the created roles, etc. Also, as part of the definition of the role, the VIOS 106 can assign one or more authorizations to the role. With reference to FIG. 2, the role AA 212 has authorization to execute the command A with a parameter of X; the command B with a parameter of Y; and the command C with a parameter of Z. Also, authorization is being added to the role AA 212 to execute the command D with a parameter of N. The role BB 214 has authorization to execute the command A with a parameter Z; the command G with a parameter of Y; and the command F with a parameter of X. The role CC 216 has authorization to execute the command F with a parameter of J; the command M with a parameter of V; and the command N with a parameter of K. Also, authorization is being removed from the role CC 216 to execute the command P with a parameter of L. Operations of the flowchart 300 continue.

The VIOS 106 assign a user to the role (310). The VIOS 106 can assign one to N number of users to the role. Accordingly, when a user signs into the system, the user account is associated with the given role. The user can then only execute those commands authorized for the given role. If the user attempts to execute a command that is not authorized for the role, the command is not executed and an error can be logged. Operations of the flowchart 300 continue.

The VIOS 106 receives, from the user, the command having the first parameter for executing in the virtual environment (312). The command can be related to any operations in the virtual environment. For example, the command create, modify, or delete a virtual I/O device; assign a virtual I/O device to a virtual partition; create, modify, or delete a role for access control; assign or remove a user to a role, etc. Also, while described with reference to one parameter, the commands can have zero to N number of parameters. In some example embodiments, each unique combination of parameters for a command can have a unique authorization in the virtual environment. Operations of the flowchart 300 continue.

The VIOS 106 determines whether the combination of the command and the first parameter is authorized for the role assigned to the user (314). The VIOS 106 can verify whether this authorization is associated with the role. In some example embodiments, this can be a two-part operation. First, the VIOS 106 can determine whether the command is authorized for the role. Second, the VIOS 106 can determine whether the parameter received for this command is authorized for the role. If the combination is not authorized for the role, the operations of the flowchart 300 are complete. Other cleanup operations can be executed. For example, the VIOS 106 can generate an error shown to the user and stored in an error log, etc. If the combination is authorized for the role, the operations of the flowchart 300 continue.

The VIOS 106 executes the command with the first parameter in the virtual environment (316). In some example embodiments, a process being executed for a command requires a given privilege level to enable execution. Accordingly, as part of the execution of the command, the VIOS 106 raises the privilege level for this process to enable execution of the command. The command is then executed and the privilege level for this process is then lowered to its previous level. Therefore, the enabled privileges are given to the running process for only a short period of time. The privileges for execution will be withheld whenever a user is not executing the command. Such a configuration improves the security by provided privileges for execution for a short time. The operations of the flowchart 300 are complete.

Dynamic updates to the roles to control access are now described. In particular, FIG. 4 illustrates dynamic updates to the defined roles for user access control in a virtual environment, according to some example embodiments. A flowchart 400 is described with reference to FIGS. 1-2.

The VIOS 106 receives a command and parameter to add to a role that defines which commands are accessible for execution by a user having the role (402). With reference to FIG. 2, the VIOS 106 can receive this command and parameter to update a role at any point while the system 200 is executing. Thus, some example embodiments allow for dynamic updates to the authorizations for a role. This command and parameter can be received from a user that is authorized to update a role. For example, a user having a role administrator role can provide such updates. The operations of the flowchart 400 continue.

The VIOS 106 updates the role to add the command and parameter to the command and parameters that are accessible for execution by the user having the role (404). This updating of a role can be performed at any point while the system is executing. Once the update of a role is complete, the user having such a role can begin executing the command/parameter combination. Accordingly, the VIOS 106 can dynamically add commands and associated parameters to a role. The system is not limited to static predefined roles. The operations of the flowchart 400 continue.

The VIOS receives a command and parameter to remove from a role that defines which commands/parameters are accessible for execution by the user having the role (406). With reference to FIG. 2 and similar to adding a command and parameter, the VIOS 106 can receive this command and parameter to update a role at any point while the system 200 is executing. Thus, some example embodiments allow for dynamic updates to the authorizations for a role. This command and parameter can be received from a user that is authorized to update a role. For example, a user having a role administrator role can provide such updates. The operations of the flowchart 400 continue.

The VIOS 106 updates the role to remove the command and parameter from the command and parameters that are accessible for execution by the user having the role (408). This updating of a role can be performed at any point while the system is executing. Once the update of a role is complete, the user having such a role can no longer execute the command/parameter combination. Accordingly, the VIOS 106 can dynamically remove commands and associated parameters to a role. The system is not limited to static predefined roles. The operations of the flowchart 400 are complete.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for optimizing design space efficiency as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a set of one or more authorizations associated with a role of a user responsive to the user entering a command with a parameter, wherein the command with the parameter is to be implemented via a first virtual partition that is configured to control access to a plurality of virtual input/output (I/O) devices by a plurality of other virtual partitions, wherein the first virtual partition and the plurality of other virtual partitions are instantiated on a same system;
determining that the role is authorized to execute the command based on the set of one or more authorizations;
determining that the role is authorized to execute the command with the parameter responsive to determining that the role is authorized to perform the command; and
executing the command with the parameter via the virtual partition.

2. The method of claim 1, further comprising:
determining a different set of one or more authorizations associated with a different role of a different user responsive to the different user entering the command with a different parameter, wherein the command with the different parameter is to be implemented via the first virtual partition;
determining that the different role is authorized to execute the command based on the different set of one or more authorizations;
determining that the different role is authorized to execute the command with the different parameter responsive to determining that the different role is authorized to perform the command; and
executing the command with the different parameter via the virtual partition.

3. The method of claim 2, wherein the command with the different parameter is not authorized for execution by the user with the role through the set of one or more authorizations.

4. The method of claim 1, wherein the command comprises instructions to create a virtual I/O device of the plurality of virtual I/O devices for representation of a physical I/O device, wherein the first parameter defines a first type of the virtual I/O device and wherein the second parameter defines a second type of the virtual I/O device.

5. The method of claim 1, further comprising:
updating, during a time when the same system is operating, the set of one or more authorizations to add a different command with a different parameter executable by the user having the role.

6. The method of claim 1, further comprising:
updating, during a time when the same system is operating, the set of one or more authorizations to delete a different command with a different parameter that had previously been executable by the user having the role.

7. The method of claim 1, wherein the first virtual partition and the plurality of other virtual partitions comprise at least one of a logical partition and a workload partition.

8. A computer program product for access control in a virtual environment, the computer program product comprising:
a computer readable storage medium having computer readable program code embodied therewith, the computer readable program code configured to,
determine a set of one or more authorizations associated with a role of a user responsive to the user entering a command with a parameter, wherein the command with the parameter is to be implemented via a first virtual partition that is configured to control access to a plurality of virtual input/output (I/O) devices by a plurality of other virtual partitions, wherein the first virtual partition and the plurality of other virtual partitions are instantiated on a same system;
determine that the role is authorized to execute the command based on the set of one or more authorizations;
determine that the role is authorized to execute the command with the parameter responsive to determining that the role is authorized to perform the command; and
execute the command with the parameter via the virtual partition.

9. The computer program product of claim 8, wherein the computer readable program code is configured to,
determine a different set of one or more authorizations associated with a different role of a different user responsive to the different user entering the command with a different parameter, wherein the command with the different parameter is to be implemented via the first virtual partition;
determine that the different role is authorized to execute the command based on the different set of one or more authorizations;
determine that the different role is authorized to execute the command with the different parameter responsive to determining that the different role is authorized to perform the command; and
execute the command with the different parameter via the virtual partition.

10. The computer program product of claim 9, wherein the command with the different parameter is not authorized for execution by the user with the role through the set of one or more authorizations.

11. The computer program product of claim 8, wherein the command comprises instructions to create a virtual I/O device of the plurality of virtual I/O devices for representation of a physical I/O device, wherein the first parameter defines a first type of the virtual I/O device and wherein the second parameter defines a second type of the virtual I/O device.

12. The computer program product of claim 8, wherein the computer readable program code is configured to,
update, during a time when the same system is operating, the set of one or more authorizations to add a different command with a different parameter executable by the user having the role.

13. The computer program product of claim 8, wherein the computer readable program code is configured to,
update, during a time when the same system is operating, the set of one or more authorizations to delete a different command with a different parameter that had previously been executable by the user having the role.

14. The computer program product of claim 8, wherein the first virtual partition and the plurality of other virtual partitions comprise at least one of a logical partition and a workload partition.

15. An apparatus comprising:
a processor; and
a machine-readable storage medium encoded with virtual partition instructions executable by the processor, the virtual partition instructions configured to execute through a first virtual partition that is configured to control access to a plurality of virtual input/output (I/O) devices by a plurality of other virtual partitions, wherein the first virtual partition and the plurality of other virtual partitions are instantiated on a same system, the virtual partition instructions configured to
determine a set of one or more authorizations associated with a role of a user responsive to the user entering a command with a parameter, wherein the command with the parameter is to be implemented via the first virtual partition;
determine that the role is authorized to execute the command based on the set of one or more authorizations;
determine that the role is authorized to execute the command with the parameter responsive to determining that the role is authorized to perform the command; and
execute the command with the parameter via the virtual partition.

16. The apparatus of claim 15, wherein the virtual partition instructions are configured to,
determine a different set of one or more authorizations associated with a different role of a different user responsive to the different user entering the command with a different parameter, wherein the command with the different parameter is to be implemented via the first virtual partition;
determine that the different role is authorized to execute the command based on the different set of one or more authorizations;
determine that the different role is authorized to execute the command with the different parameter responsive to determining that the different role is authorized to perform the command; and
execute the command with the different parameter via the virtual partition.

17. The apparatus of claim 16, wherein the command with the different parameter is not authorized for execution by the user with the role through the set of one or more authorizations.

18. The apparatus of claim 15, wherein the command comprises instructions to create a virtual I/O device of the plurality of virtual I/O devices for representation of a physical I/O device, wherein the first parameter defines a first type of the virtual I/O device and wherein the second parameter defines a second type of the virtual I/O device.

19. The apparatus of claim 15, wherein the virtual partition instructions are configured to,
update, during a time when the same system is operating, the set of one or more authorizations to add a different command with a different parameter executable by the user having the role.

20. The apparatus of claim 15, wherein the virtual partition instructions are configured
update, during a time when the same system is operating, the set of one or more authorizations to delete a different command with a different parameter that had previously been executable by the user having the role.
